(19) United States
(12) Patent Application Publication
(10) Pub. No.: US 2010/0257067 A1
(43) Pub. Date: Oct. 7, 2010

(54) REMOTE WEB SERVICE APPLIANCE FOR POINT OF SALE ACTIONS

(76) Inventor: Tai Man Chan, Brookline, MA (US)

Correspondence Address: TAI CHAN, 1856 BEACON STREET, SUITE 2E, BROOKLINE, MA, 02445, US

(21) Appl. No.: 12/564,628

(22) Filed: Sep. 22, 2009

Related U.S. Application Data
(60) Provisional application No. 61/165,768, filed on Apr. 1, 2009.

(51) Int. Cl. G06Q 30/00; G06Q 20/00; H04W 4/00; G06F 15/16

(52) U.S. Cl. 705/21; 705/26; 705/40; 455/466; 709/203

(57) ABSTRACT

This disclosure relates to systems and methods for implementing point of sale actions. The disclosure more specifically relates to systems and methods for receiving commercial transaction requests placed by a customer at a location other than where the transaction is to be fulfilled. The disclosure also provides for systems and methods for initiating payment at a sales location for remote payment satisfaction.

### RELATED APPLICATIONS

This application claims the benefit of priority under 35 U.S.C. §119(e) from co-pending, commonly owned U.S. provisional patent application Ser. No. 61/165,768, entitled “Remote Control of Point of sale Actions,” filed Apr. 1, 2009.

### FIELD OF THE DISCLOSURE

The present disclosure relates to remotely coordinating and executing commercial transactions. The systems and methods disclosed herein generally relate to an Internet appliance for use at a physical retail location and/or service provider where commercial transactions are fulfilled.

### BACKGROUND OF THE DISCLOSURE

The Internet revolution has sparked a growing wealth of technological advancements for electronic commerce, web services, web marketing, and electronic payment. Yet many retail stores, especially small to mid-sized stores, are ill equipped to take advantage of these advancements. Further, most of the Internet solutions are designed around online marketplaces for products or services, where the fulfillment of those commercial transactions do not need to be processed immediately and do not need a physical store front.

While large retailers and service providers allow for online order placement with the delivery of the product almost immediately at their retail store location, their solutions to implement such near immediate order fulfillment are costly and complex. Implementing such a system requires several components, including private database servers, private networks, local point-of-sale servers, and internal teams of information technology professionals for backend support. Even with such an elaborate system and configuration, the implementation still limits the store's server to access only private data and web services that the store itself provides.

Conventional point-of-sale printers receive data via local data communication techniques, such as serial, USB, parallel, or Ethernet connections to a local terminal and/or computer. These conventional techniques limit the printer to only being capable of printing orders, receipts, etc. at the location where the printer resides. With the growth of electronic commerce (“e-commerce), such as sales over the Internet using a computer or a mobile phone, many sales transactions are carried out at remote locations or servers where the printer and terminal do not reside. Thus, there are businesses that would like to add e-commerce capability to their business model without the need to add or update their current computers and/or point-of-sale systems.

Similarly, current payment solutions at retail and service locations are generally limited to cash, check, or credit card systems. E-commerce, however, has provided alternate ways of transferring funds and performing payment. Accordingly, retail and service locations would better serve their customers if the customers were provided the option of performing payment via one of these alternatives.

Another known order entry and payment processing system is a self service kiosk machine. These devices can be seen, for example, at parking lots, theaters, train stations, and self check in/out counters at hotels and airports. These systems are highly customizable and can be built with a wide range of peripherals for payment processing, security, and printing. These systems, however, are costly and complex to set up.

### SUMMARY OF THE DISCLOSURE

This disclosure relates to systems and methods for the remote fulfillment of commercial transactions. Embodiments disclosed herein include systems and methods of receiving over a cellular network a commercial transaction request using a thin client Internet appliance, where the request is made at a location other than where the commercial transaction is to be fulfilled, including: wirelessly receiving over the cellular network a commercial transaction request at the appliance the fulfillment location originating from a customer interfacing with an order placement web server; recording the commercial transaction request at the fulfillment location by way of a peripheral and/or host device in electronic communication with the appliance; and completing the commercial transaction to provide the requested services and/or products to the customer.

Embodiments can further include converting at a web proxy server a customer request into the commercial transaction request for transmission to the fulfillment location. In one embodiment, the systems and methods further interrogate the order placement server to poll for requests to be received. Wireless reception occurs via short message service (“SMS”) or multimedia messaging service (“MMS”) or via the Internet through the cellular network. The peripheral and/or host device can be a printer wherein the recording of the customer's request occurs through printing a receipt. The peripheral and/or host device can also be a point-of-sale terminal.

The disclosure also contemplates embodiments for receiving a commercial transaction request over a cellular network, where the request is made at a location other than where the commercial transaction is to be fulfilled, including: a wireless radio configured and arranged to receive over the cellular network a commercial transaction request at the fulfillment location originating from a customer interfacing with an order placement web server; and a processing unit configured and arranged to interface with a peripheral and/or host device to record the commercial transaction request for fulfillment of the commercial transaction.

In these embodiments, the processing unit can be further configured and arranged to interrogate the order placement server to poll for requests to be received. The commercial transaction request can be received via SMS or MMS or via the Internet. The processing unit can be remotely programmable over the cellular network to interface with the peripheral and/or host device. The peripheral and/or host device can be a point-of-sale terminal or a printer. The processing unit can also be configured and arranged to interface with both a point-of-sale terminal and a printer such that the printer is shared with the terminal for the use of the printer without interference to the terminal's normal operation with the printer. The processing unit can be configured and arranged to operate as a USB slave device to a USB host or as a USB host to USB slave device.

Embodiments also include systems and methods for providing payment satisfaction in a commercial transaction at a location where the commercial transaction is to be fulfilled, including: inputting commercial transaction information for payment satisfaction through an on-line payment system web service provider; transmitting a request to the on-line payment system web service provider including the transaction information to use the on-line payment system web service provider's Internet payment services; receiving a payment status response from the on-line payment system web service provider; and processing a positive payment status response to fulfill the commercial transaction. The transmitting can be performed by way of a cellular network. The receiving step can occur after a customer confirms the release of funds to authorize payment. It could also occur after a customer initiates payment after the customer is provided with the commercial transaction information.

The present disclosure also contemplates embodiments for payment satisfaction in a commercial transaction at a location where the commercial transaction is to be fulfilled, including: a processing unit configured and arranged to interface with an input device to receive commercial transaction information for payment satisfaction through an on-line payment system web service provider and with a peripheral and/or host device for processing a commercial transaction for which payment is transferred; and a network adapter in communication with the processing unit configured and arranged to transmit a request to the on-line payment system web service provider including the transaction information to use the on-line payment system web service provider's Internet payment services and to receive a payment status response from the on-line payment system web service provider. The network adapter can be a wireless radio configured and arranged to transmit and receive data over a cellular network. The processing unit can be remotely programmable via the network adapter to interface with a peripheral and/or host device. The processing unit can also be remotely programmable via the network adapter to interface with an on-line payment system web service provider. The peripheral and/or host device can be a point-of-sale terminal or a printer.

Embodiments also include systems and methods for consuming a third party web service on the Internet by way of a thin client appliance and a client-server network architecture including: transmitting from the thin client appliance over the Internet via a cellular network to a web service proxy server a web service consumption request, wherein the web service proxy server receives the request, generates a service request message based on an established protocol to transmit the service request message in accordance with the third party web service's API specification and protocol, and receives a return message from the third party web service; and receiving over the Internet at the thin client appliance transaction information from the web service proxy server, wherein the transaction information is extrapolated from the return message. The embodiments can also include transmitting to the web service proxy server any information for storage in a database and/or to be made available over the Internet by providing the web service API interface. The reception can occur via a cellular network.

Embodiments also include a device for consuming a third party web service on the Internet using a client-server network architecture including: a processing unit configured and arranged to generate a web service consumption request and to interpret transaction information; and a network adapter configured and arranged to transmit over the Internet to a web service proxy server a web service consumption request, wherein the web service proxy server receives the request, generates a service request message based on an established protocol to transmit the service request message in accordance with the third party web service's API specification and protocol, and receives over the Internet a return message from the third party web service, and to receive transaction information from the web service proxy server, wherein the transaction information is extrapolated from the return message. The network adapter can be a wireless radio configured and arranged to connect to the Internet via a cellular network.

The disclosure also provides systems and methods for completing a commercial transaction, where a commercial transaction request is made at a location other than where the commercial transaction is to be fulfilled, including: receiving at the fulfillment location a code input and obtained by a customer, wherein the customer placed a commercial transaction request over the cellular network with an order placement server that provided the customer with the code; transmitting the inputted code over the cellular network to a remote server, where the remote server matches the received code with the commercial transaction request; and communicating to a peripheral and/or host device the details of the matched commercial transaction request for completion of the commercial transaction.

Embodiments also include a device for completing a commercial transaction, where a commercial transaction request is made at a location other than where the commercial transaction is to be fulfilled, including: a processing unit configured and arranged to receive an inputted code associated with a commercial transaction request and to transmit to a peripheral and/or host device the details of the matched commercial transaction for completion of the commercial transaction; and a cellular wireless radio configured and arranged to transmit the inputted code to an order placement server for matching the code with its associated commercial transaction and to receive details of the matched commercial transaction request from the order placement server.

### BRIEF DESCRIPTION OF THE DRAWINGS

For the advantages of this disclosure to be readily understood, the drawings provided represent specific embodiments of the systems and methods contemplated in this disclosure.

FIG. 1 is a perspective view of one embodiment of a stand alone unit contemplated in this disclosure.

FIG. 2 is a rear view of the embodiment of FIG. 1.

FIG. 3 is an embodiment of a power cord and adapter for the embodiment in FIG. 1.

FIG. 4 is a block diagram of an embodiment of a system of an appliance described in the present disclosure.

FIG. 5 shows an implementation of an embodiment of the present disclosure.

FIG. 6 is an architectural diagram of an embodiment of a system of the present disclosure.

FIG. 7 illustrates one example of an architecture implementing an embodiment of the system of this disclosure.

### DETAILED DESCRIPTION OF THE DISCLOSURE

The present disclosure relates to thin client appliances which connect to a server or system for real time access to services and information relating to commercial transactions. The appliances can operate as stand alone units (such as the embodiment shown in FIGS. 1-3 and described hereinafter) or incorporated into other larger systems to provide a print-out or to display commercial transaction data. For example, they can also be a part of a point-of-sale system to update the system with data from remotely placed commercial transactions as described further below.

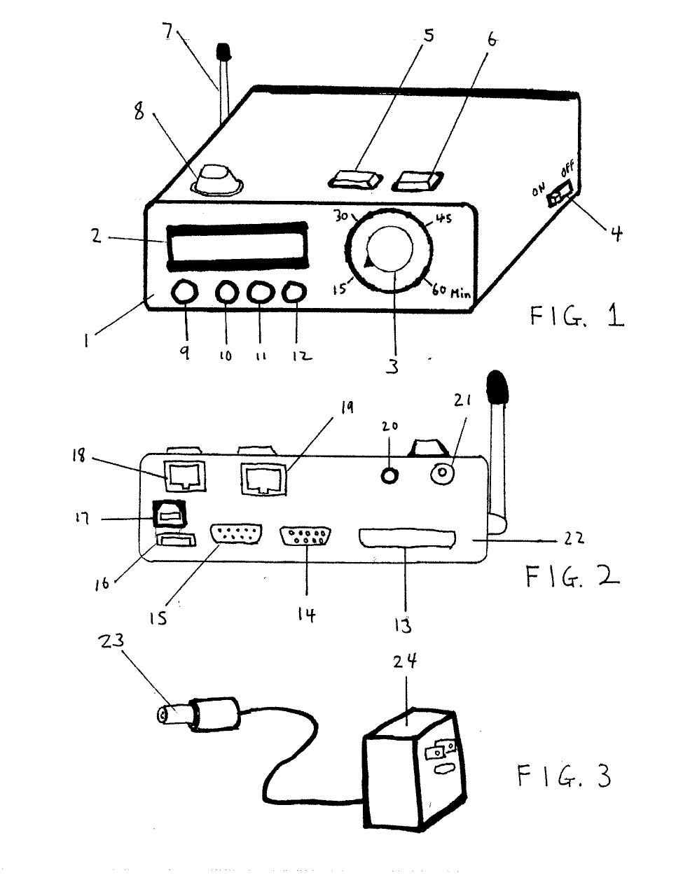

The term point-of-sale (“POS”) refers to the location where a sales transaction occurs, where the items or services of the transaction are provided, catalogued, rendered/tendered, or otherwise completed or fulfilled. These locations include but are not limited to merchandise retail stores, supermarkets, hotels, stadiums, restaurants, laundromats, or professional offices such as a doctor's office. A POS terminal refers to the hardware and software used to perform those actions, such as for checkouts. In contrast, a credit card payment device does not constitute a POS terminal because its only purpose is to process a payment with the merchant card services. POS systems refers to all the hardware and software used, for example, for item entry (which can be as simple as the item cost), payment processing, and completion of commercial transactions. POS systems vary from simple tools, such as a standard cash register, to complex systems, such as a POS terminal, bar code scanner, credit card payment terminal, weight scale, database sever, and/or software to help track inventory and other operations and transactions. Referring to FIGS. 1-3, an embodiment of a standalone point-of-sale appliance is illustrated. The illustrated appliance includes a front panel 1, a graphical display 2, a control knob 3, an on/off switch 4, buttons to check for incoming data 5,6, antenna 7, LED indicator light 8, and various control switches 9-12. The embodiment also includes a parallel port 13, serial ports 14,15, USB ports 16-17, an RJ-11 port 18, and an RJ-45 port 19 for interfacing with various telecommunication and peripheral devices. A power adapter 24 and cord 23 shown in FIG. 3 can be used to connect the embodiment to a standard power supply.

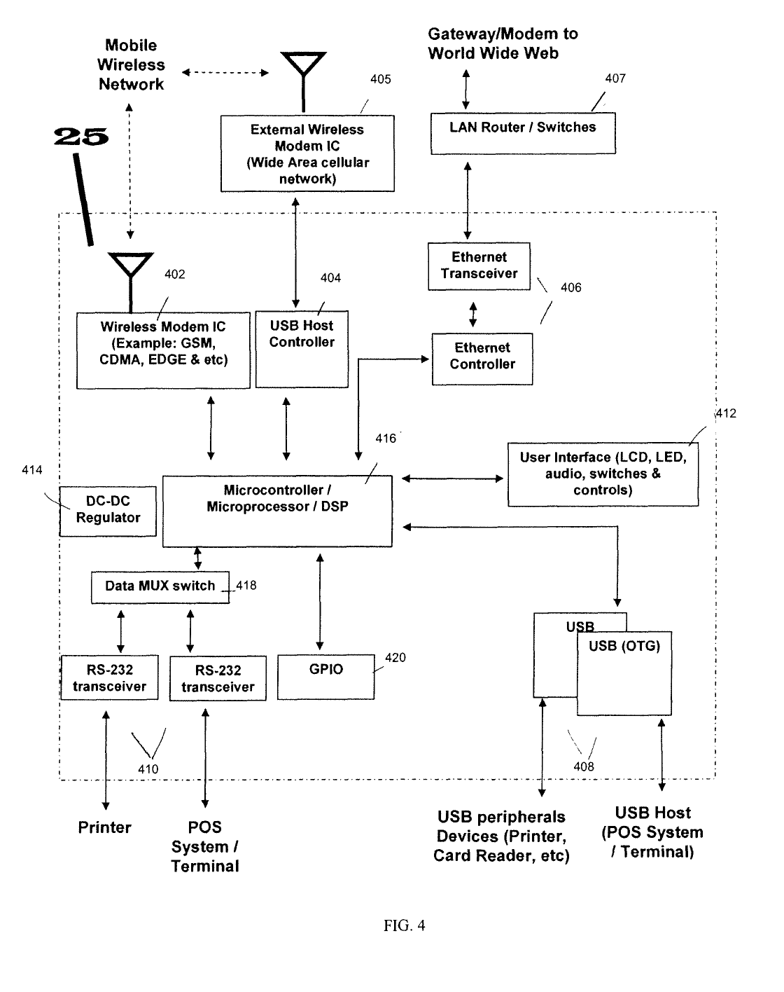

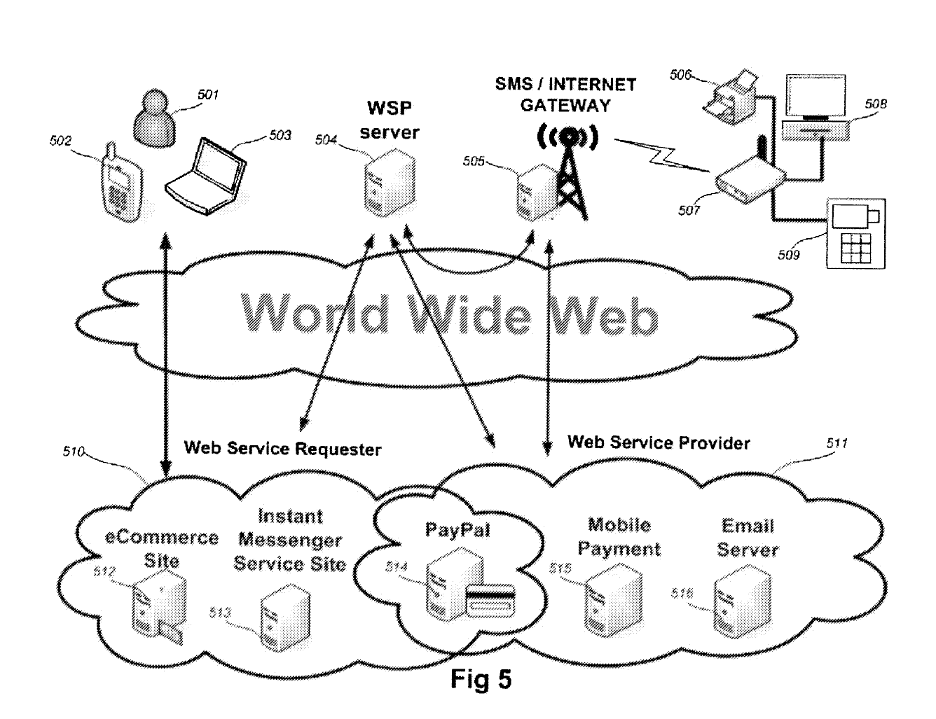

FIG. 4 is a block diagram showing various components that are included in one embodiment of a standalone point-of-sale appliance and FIG. 5 illustrates a system implementing such the appliance. As shown in FIG. 4, the embodiment comprises a wireless modem 402, a USB host controller 404 which can interface with an external wireless modem 405, an Ethernet controller and transceiver 406 to interface with a local area network router/switch 407, USB ports 408 which can support On-The-Go connectivity and which can interface with USB peripheral devices and/or USB printers or a point-of-sale terminal/system, and serial ports 410 to connect to a printer and/or a point-of-sale system/terminal. The embodiment further comprises a user interface 412 which can include an LCD display, LED indicators, audio components, switches, and/or controls. The appliance receives power from an external power source which is connected through DC-DC regulator 414. A processing unit 416, such as a microcontroller, microprocessor, and/or digital signal processor, in conjunction with a multiplexer 418 and a general purpose input/output bus 420, controls the operation of these various components. This processing unit can be any device programmable and/or adapted to carry out the functions described herein.

In certain embodiments, the wireless modem 402, 405 can be any telecommunication device which operates over mobile and/or cellular networks. The modem can transmit and receive short message service (“SMS”) and multimedia messaging service (MMS). It can also communicate over the Internet through a cellular network.

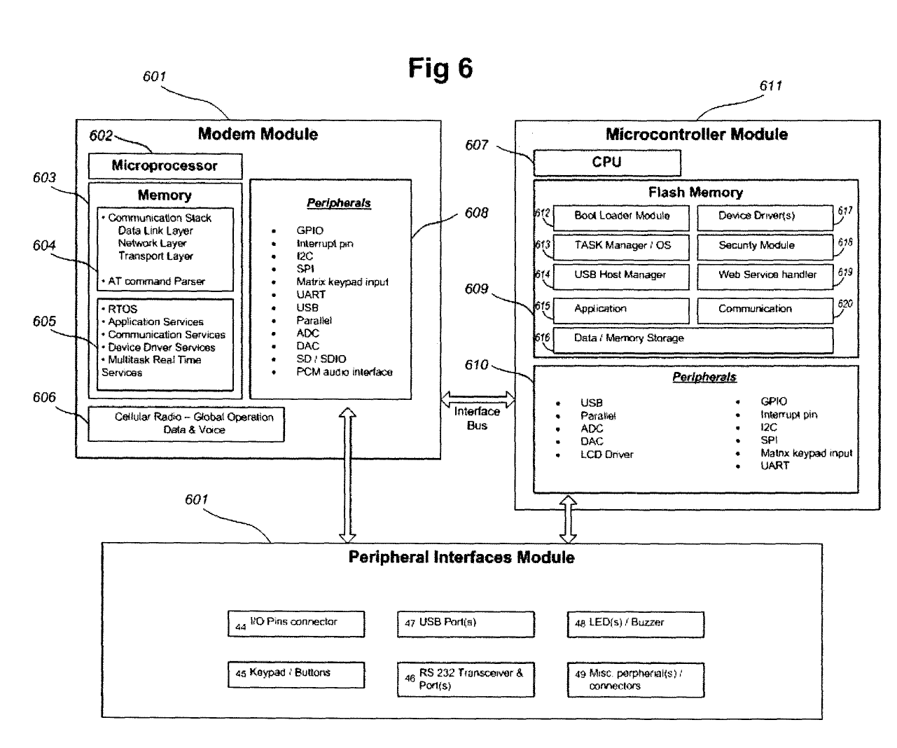

Referring to FIG. 6, an architectural block diagram of one embodiment of an appliance in accordance with the present disclosure is illustrated. The appliance includes three major blocks: a modem module 601, a microcontroller module 611, and a peripheral interface module 612. Each module entity is illustrated with building blocks representing hardware and/or software components.

The modem module 601 includes a processor 602, and its corresponding circuitry and components, such as flash memory 604 and DRAM, a cellular radio 606 and peripherals 608. This module also comprises the internal memory 603 for code and data storage.

Preferably, the primary function of module 601 is to provide cellular modem functionality to the appliance. The module 601 includes communication firmware 604 which provides the communication stack, including the data link layer, network layer, and transport layer for digital communication. The communication firmware 604 can also include a command parser to interpolate messages and responses to requests from a module connected through an interface bus to support the modem module's 601 primary function. The communication firmware 604 in conjunction with services from its operating system manages the control and use of the cellular radio for communication.

The modem module 601 can be acquired from a manufacturer, such as MultiTech® Systems, as a complete module 601. Some modules will have different sets of features, services, and peripherals. In a more integrated module 601, a real time operating system can be provided with software service 605 to support a customized application. These high end modules typically provide a feature rich set of peripherals for the development of a completed system with minimal additional components in the design. In a highly integrated module, for example, the appliance can be programmed with custom firmware that supports external code storage 616 for drivers for peripherals. In one example, the device driver can program the general purpose input/output (“GPIO”) to support driving LEDs. In another example, the device driver can program the USB port to emulate a USB keyboard or USB credit card payment terminal. This emulation permits interfacing embodiments of the present disclosure with a pre-existing POS system without installing custom software or drivers on the POS system.

If the USB peripheral of module 601 supports USB On-the-Go (“OTG”), then, the driver can be developed to have the device be a host device, instead of a slave device. Such an embodiment permits the use of an external USB keypad with an LCD screen (e.g. USB phone) to be used as an input device. In another example a device driver can provide dual-tone multi-frequency (“DTMF”) function to a digital to analog converter (“DAC”), thereby permitting operation with a POTS phone line. This capability is useful in embodiments of this disclosure which communicate data over the POTS for services such as call forwarding.

The application services 605 can incorporate the function of embedded Simple Object Access Protocol (“SOAP”), such as eSOAP, for web service handling and bypass the use of a web service proxy (“WSP”) server if necessary to gain access to a particular web service. Use of embedded SOAP depends on the processor and the OS flexibility of the modem module 601. The modem module 601 can use external storage to store much of the function code for communication with a WSP server, the device driver for the supported peripherals, and any additional service to be provided.

The microcontroller module 611 can be a system on a chip solution. The microcontroller module 611 can be used to provide external memory to the modem module 601 for code storage within its own flash memory and on board memory. The microcontroller 611 is self-programmable. This feature, in conjunction with a boot loader and security module, allows reprogramming of the code and data stored in the data/memory storage 616. Thus, support for different connected devices and application services is possible without large software installations for every conceivable device. Such an approach limits the size of the software footprint and reduces the overall component count for the design.

For example, a WSP server can be used to reprogram the code stored in the data/memory storage 616 of a device via cellular networks in accordance with the present disclosure. The WSP server would provide a web application for the configuration of the hardware. Upon commitment to the configuration, the WSP server would compile a new image of the code and data. The WSP server would then log onto a cellular gateway server to transmit an SMS message with an encrypted security key for unlocking the device for reprogramming. The device would then respond with a session ID to be used with each packet of the new image to be sent over the Internet. After the transfer, the device would send the WSP server a cyclic redundancy check (“CRC”) checksum of the received image. The WSP would lastly confirm and authorize a reprogramming of the section of the memory by SMS security command.

In other embodiments contemplated in the present disclosure, the modem module 601 may not require any features beyond basic modem capability, such as a device purely for printing out receipts documenting commercial transactions. In such instances, the module 601 does not support custom applications or various peripherals. The modem module 601 only functions as a modem. In this configuration, the microcontroller module 611 serves as an application engine 615, the web service handler 619, the device driver manager 617, USB host manger 614, and its own task manager/OS 613. The microcontroller module 611 provides peripherals to support the function of the application internally and connects directly to the peripheral interface module. While the microcontroller 611 still divides the available memory 616 for storage of driver and application service code, it does so for its own use. The storage is still reprogrammable, as stated above.

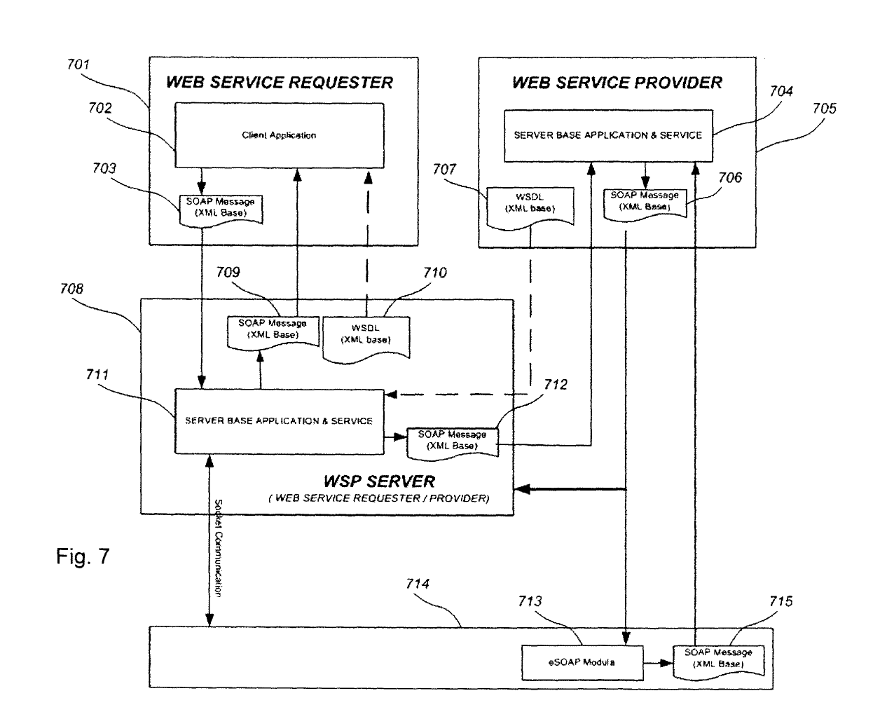

Referring now to FIG. 7, the block diagram illustrates an example of the relation between a WSP server 708, web service requester 701, web service provider 705, and an appliance 714 of the type described hereinbefore, in a network environment.

In one embodiment, an appliance 714 can be used to inform a remote server of the local inventory at a location. In such an embodiment, the appliance is first programmed with a service to contact the WSP server upon receiving a change in inventory. The inventory information can be made available to the appliance via an input device, such as a POS terminal or keypad. The appliance transfers updated inventory information to the WSP server by opening a socket and establishing a message link that allows the WSP server to receive the updated information. The WSP server then updates its own record of the inventory. The record is now made available through the use of the web service provided by the server.

By way of example, web service can be defined by the World Wide Web Consortium (“W3C”) as “a software system designed to support interoperable machine-to-machine interaction over a network. It has an interface described in a machine-processable format (specifically WSDL). Other systems can interact with the Web service in a manner prescribed by its description using, for example SOAP messages, typically conveyed using HTTP with an XML serialization in conjunction with other Web-related standards.” As used herein, web service refers to this definition and any future variations of the definition. The WSP server's application 711 will provide a WSDL for its web services that are available.

In one embodiment, a web site can use the WSDL information to create a SOAP message to request inventory information. The message is sent to the WSP server in which an application parses the message, retrieves the information from its own record (SQL database), and responds with a SOAP message to the client application, a web application in this case. One reason one might not use the appliance to directly transmit inventory information is to avoid overloading the appliance which can result in a “denial of service” (although clearly in some circumstances it may be appropriate to do so). This approach allows for the use of multiple WSP servers to expand the remote servicing capability of the entire system. For example, a appliance contemplated in this disclosure can use another WSP server to server up information on preparation time for preparing a purchase order. This task specialization permits computing and load distribution over the overall system.

An appliance in accordance with this disclosure can also use web services over the Internet to transmit SMS or MMS messages, which can be achieved using one of two methods. In the first method, the WSP Server is preconfigured with information from the web service provider's WSDL to access the SMS/MMS message service. The service is made available to the appliance by a special command code. The service can be made available to the appliance as a command to send a predefined message (e.g. “Your table is ready”) in which only the mobile number is needed along with the command code. The appliance can receive the mobile number from one of its input devices and transmit the command code along with the mobile number by either SMS/MMS message (in which the WSP server would be required to check the SMS queue in the cellular gateway server), or by a point to point communication link. Once the message is sent, it is up to the WSP server to generate the SOAP message to the Web Service Provider of the SMS/MMS service. The Web Service Provider can respond with a callback SOAP message.

In another embodiment contemplated herein, the WSP server is not employed in the consumption of the web service, but an embedded web service client engine (e.g. eSOAP) is built into the program image in a microcontroller. The engine allows for the generation of an service request message for the consumption of the web service. The message is sent to the web service provider but no callback function is to be provided by the appliance. While callback is possible, it is not necessary unless confirmation is needed.

In one embodiment, these appliances use a data network to communicate with an offsite server by cellular modem or wire modem. The appliance can use other web services such as payment by PayPal® account, delivery directions from Google Map, and other services available on the internet.

The present disclosure relates to remote order placement at a point-of-sale (“POS”) using a communication device such as telephone modem, fax modem, mobile telecommunication modem (CDMA, GSM, GPRS, HSDPA, EDGE, etc.), or Ethernet adapter. Unlike general purpose modems, various embodiments disclosed herein are capable of decoding and processing received data for interfacing with and order placement at any point-of-sale location.

Referring back to FIG. 5, the diagram illustrates an embodiment of an architecture of a system disclosed herein. In one embodiment, the appliance can be used to consume a payment processing web service from a site such as PayPal®. In this particular embodiment, the appliance is architecturally based on a thin client topology which uses remote servers for handling process-intensive activities. The appliance can have a POS terminal and a receipt printer connected. The WSP server is responsible for the servicing, translating, and passing requests for web services to and from the Internet. Other benefits of using a WSP server including providing filtering of non-supported service requests from the web service requester, parsing of messages to and from the Internet, and the SMS message retriever from the cellular gateway server. The use of the WSP server helps hide the IP address of the appliance, helping limit unwanted traffic from the internet.

A POS terminal can transmit a request to the appliance to initiate a payment with, for example customer PayPal® identification and transaction data. The appliance can then establish a point to point socket communication or other secure session with the WSP server through the cellular gateway to the Internet. In the foregoing illustrated implementation the WSP server is preconfigured to offer PayPal® services to the appliance as a command code which requires only the PayPal® merchant identification, customer's PayPal® identification, and amount to be charged. The appliance creates and transmits a PayPal® service request message to the WSP server. The WSP translates the service request into a series of SOAP (XML based) API calls to the PayPal® web service provider. PayPal® will be directed to request for payment from the customer PayPal® account. PayPal® then contacts the customer with a request for payment. Whether the customer receives the notification or not, upon PayPal®'s receipt of the request, the customer can login to their PayPal® account and release the payment to the merchant (identified by merchant identification). Upon release of payment, PayPal®'s Instant Payment Notification service will notify the WSP server by posting the status via a private URL address. The WSP server then updates the status of the payment by establishing a direct link to the appliance and transmitting the status of the payment to the device. Upon receipt of the payment update at the point-of-sale, the appliance will transmit its data to the printer or to the POS terminal for to fulfill the order.

In another exemplary embodiment, an appliance in accordance with the present disclosure can be used to provide mobile payment services from a payment system offered by company such as Bongo®, Mocapay®, Zong®, Boku®, Obopay®, etc, by interfacing with their web service through the use of a Web Service API or HTML URL interface. In this embodiment, the appliance is only connected to a keypad with a LCD display and a printer. A keypad is used to submit the customer's account user ID (e.g. mobile number) and transaction amount to the appliance. The appliance establishes a point to point socket communication or other secure session with the WSP server through a cellular gateway to the Internet. The WSP server is preconfigured to offer the selected payment service(s) to the appliance as command code(s) which requires only the mobile number and the amount to be charged. The appliance creates and transmits a payment service request message with the command code to the WSP server. The WSP server then translates the service request into a series of SOAP (XML based) API calls to the mobile payment service provider's server. The mobile payment service provider then generates a notification message to the patron's mobile number with a request for payment. The customer can reply with confirmation to release the funds. In one alternative method, the notification message is not sent to the patron but instead the business account information is communicated to the patron for the patron to initiate the payment to the account. Once the WSP server detects the receiving and clearing of the payment, the WSP server will then update the status of the payment by establishing a direct link to the appliance and transmitting the status of the payment to the device. Upon receipt of the payment update at the point-of-sale, the appliance will transmit its data to the printer or to any connected device according to its programming.

Another embodiment of this disclosure can be used to implement a kiosk for commercial transactions. In this embodiment, the appliance functions as a ticket printer for the kiosk terminal. Thus, this embodiment can fulfill the same functions as a typical self-service kiosk, such as those found in parking lots, theaters, train stations, and self check in/out counters at hotels and airports. Referring to FIG. 5 for an illustrated example, the kiosk software is located at an eCommerce site 512. The customer accesses the kiosk software via the site using a web-enabled device 502, 503, such as a cell phone. Upon completing the commercial transaction, the site generates a series of numbers, or a key, representing the completed transaction. The key is provided to the customer on screen and a copy can be sent to the customer by email or SMS. The eCommerce site 512 then requests the submission of the transaction details to the WSP server's database. The submission of the information is performed by utilizing a web service offered by the WSP server for this particular type of transaction. The WSP server stores the key and the details of the transaction into the database. The user can then walk up to one of the kiosk terminals, with a connected ticket printer and keypad, and enter the key. The appliance would then establish a connection with the WSP server through the cellular gateway and submits the key. The WSP server retrieves the transaction detail for the purchase based on the key provided. It then constructs a series of printing instruction messages and transmits it to the appliance for printing ticket. Upon successful printing of the ticket, the appliance will notify the WSP server of the status.

Similarly, a printer and an appliance in accordance with this disclosure can be set up next to a computer for making purchases over the Internet or other network. In such a system, a customer can make a purchase on-line and receive a receipt from the printer, even though the computer and printer are not directly connected. For example, a consumer can access a retailer's website at a kiosk, and once the transaction completes at the retailer's location, a receipt can be printed at a printer at or near the kiosk, even though the kiosk and printer are not directly connected.

Yet another embodiment of the present disclosure permits fulfillment of remote electronic commerce transactions at a point of sale location. One purpose of this embodiment is to enable a POS printer to print information, including receipts, sale orders, and/or tickets or to enable a POS system or terminal to access information of sale transactions on-site for electronic commerce transactions initiated or completed remotely, such as over the Internet or mobile wireless phone network. According to one embodiment, the system acts as printer controller capable of communicating and receiving data and control information over some form of telecommunications network such as the Internet or mobile wireless networks, such as CDMA, GSM, GPRS, HSDPA, or EDGE.

The following is a brief description of the operation of one such embodiment. First the sender or caller identification information is checked or qualified. Upon acceptance of the connection or data, sale data information is received from an offsite server. The data is decoded, processed, and converted into a series of printing instructions. If the printer is attached indirectly, the data is stored until the printer is ready to receive the printing information. While storage capability permits later processing and printing upon the end user's request, the printing can also be set to automatically print without manual control. If the printer is attached directly, but is shared with a POS system or terminal, then the printing can wait until the printer is not being utilized by the POS system or terminal. For example, after a set period of time, an internal switch can take the control of the printer away from the POS system or terminal for printing. In this example, after printing is complete, control of the printer will be reestablished with the POS system or terminal. If the printer is attached directly and is not shared with another device, depending upon user selection an audio or visual alarm can alert the end user on the arrival of data ready for printing or generate the alarm after completion of printing.

As in other embodiments, this embodiment can also be remotely controlled by a server or terminal for reprogramming and setup. Functionality can thus be modified to be simple from the perspective of the end user and flexible from the perspective of the remote controller.

Unlike a fax machine, which incorporates a fax modem in conjunction with an office printer, this embodiment can support the use of a receipt printer and its corresponding paper. While a fax machine encodes a graphical image of the original document for transfer, the present disclosure contemplates encoding raw data of the message for data transfer, resulting in a shorter duration for transferring the entire message. Also contemplated is a smart call screening and identification feature which only responds to recognized senders or callers when identification information meets the preset criteria.

The appliance of another embodiment can be a standalone unit that has at least one communication port for interfacing with any printer for external printing. Alternatively, the appliance can have at least one communication port for interfacing with a POS printer for external printing. Similarly, the appliance can have at least one communication port for interfacing with the printer queue of the POS system or terminal. This allows the device to print through the POS system or terminal. The device could also interface with the POS system or terminal for the purpose of acting as a switch between itself and the POS system or terminal to a share a attached printer. Further, this embodiment also allows for the sharing of a single POS printer by allowing direct access to the printer from the device through a connection with the POS system.

As opposed to being a standalone unit, the appliance can also be built into a POS system for the purpose of communicating with a remote server or terminal for the purpose of printing e-commerce sale transaction data. Similarly, it could also be built into a printer as an added function, for the purpose of receiving data and driving the printing process.

Further, embodiments of this disclosure can be integrated into any system which provides services or products, such as a self service vending machine. By interfacing an appliance with a peripheral and/or host device of the system, such as the vending machine, one can perform payment over the Internet. Using an Internet access device (e.g. smartphone, computer, or PDA) the patron can access the product or service shopping and payment site to place the order. The vending machine's associated web commerce site will perform the sale transaction and transfer the purchase order data to the appliance. The patron is then presented with purchase identification information (e.g. Serial number, Barcode, etc). The patron can then use the identification information at the vending machine to identify the sale transaction for the purpose of receiving the product(s) or service(s) for the sale. Such use of the appliance allows for the shopping and payment of goods and services to be done anywhere in world and allows a merchant to offer Internet payment options other than a credit card. The embodiment can be extended but not limited to self service car washes, laundry machines, and gas station pumps.

Wireless communications used to receive and print data can be achieved via mobile wireless data and voice communication networks, including but not limited to, CDMA, GSM, GPRS, HSDPA, and EDGE. Also, embodiments utilizing wireless systems can also receive data by local wireless networks, including but not limited to, Wi-Fi, Bluetooth, RF (ISM), IRDA, and Zigbee.

An embodiment contemplated herein can also act as a host USB controller to interface with an external modem, either through wireless or wired connections, for communication with a remote offsite server to obtain commercial transaction data. While Ethernet adapters are known in the art, embodiments of this disclosure permit thin client functionality to provide the secure and intelligent support needed for safe accessibility by the remote server.

In various embodiments disclosed herein, a user interface to initiate data transfer to the remote server can be provided in the appliance. For example, a user can select a delivery time for a delivery order, an availability time for a sales order pickup, or business hours of operation.

While the disclosure makes reference to the details of preferred embodiments, it is to be understood that the disclosure is intended in an illustrative rather than in a limiting sense, as it is contemplated that modifications will readily occur to those skilled in the art, within the spirit of the disclosure and the scope of the appended claims.

I claim:

1. A method of receiving over a cellular network a commercial transaction request using a thin client Internet appliance, where the request is made at a location other than where the commercial transaction is to be fulfilled, comprising:
wirelessly receiving over the cellular network a commercial transaction request at the appliance at the fulfillment location originating from a customer interfacing with an order placement web server;
recording the commercial transaction request at the fulfillment location by way of a peripheral and/or host device in electronic communication with the appliance; and
completing the commercial transaction to provide the requested services and/or products to the customer.

2. The method of claim 1, further comprising the step of converting at a web proxy server a customer request into the commercial transaction request for transmission to the fulfillment location.

3. The method of claim 1, further comprising the step of interrogating the order placement server to poll for requests to be received.

4. The method of claim 1, wherein the wireless reception occurs via short message service (“SMS”) or multimedia messaging service (“MMS”) through the cellular network.

5. The method of claim 1, wherein the wireless reception occurs via the Internet through the cellular network.

6. The method of claim 1, wherein the peripheral and/or host device is a printer.

7. The method of claim 6, wherein the recording of the customer's request occurs through printing a receipt.

8. The method of claim 1, wherein the peripheral and/or host device is a point-of-sale terminal.

9. A thin client Internet appliance for receiving a commercial transaction request over a cellular network, where the request is made at a location other than where the commercial transaction is to be fulfilled, comprising:
a wireless radio configured and arranged to receive over the cellular network a commercial transaction request at the fulfillment location originating from a customer interfacing with an order placement web server; and
a processing unit configured and arranged to interface with a peripheral and/or host device to record the commercial transaction request for fulfillment of the commercial transaction.

10. The appliance of claim 9, wherein the processing unit is further configured and arranged to interrogate the order placement server to poll for requests to be received.

11. The appliance of claim 9, wherein the commercial transaction request is received via SMS or MMS.

12. The appliance of claim 9, wherein the commercial transaction request is received via the Internet.

13. The appliance of claim 9, wherein the processing unit is remotely programmable over the cellular network to interface with the peripheral and/or host device.

14. The appliance of claim 9, wherein the peripheral and/or host device is a point-of-sale terminal.

15. The appliance of claim 9, wherein the peripheral and/or host device is a printer.

16. The appliance of claim 15, wherein the processing unit is further configured and arranged to interface with a point-of-sale terminal and the printer such that the printer is shared with the terminal for the use of the printer without interference to the terminal's normal operation with the printer.

17. The appliance of claim 9, wherein the processing unit is further configured and arranged to operate as a USB slave device to a USB host.

18. The appliance of claim 9, wherein the processing unit is further configured and arranged to operate as a USB host to USB slave device.

19. A method of providing payment satisfaction in a commercial transaction at a location where the commercial transaction is to be fulfilled using a thin client Internet appliance, comprising:
inputting commercial transaction information for payment satisfaction through an on-line payment system web service provider;
transmitting a request to the on-line payment system web service provider including the transaction information to use the on-line payment system web service provider's Internet payment services;
receiving a payment status response from the on-line payment system web service provider; and
processing a positive payment status response to fulfill the commercial transaction.

20. The method of claim 19, wherein the transmitting step is performed by way of a cellular network.

21. The method of claim 19, wherein the receiving step occurs after a customer confirms the release of funds to authorize payment.

22. The method of claim 19, wherein the receiving step occurs after a customer initiates payment after the customer is provided with the commercial transaction information.

23. A thin client Internet appliance for payment satisfaction in a commercial transaction at a location where the commercial transaction is to be fulfilled, comprising:
a processing unit configured and arranged to interface with an input device to receive commercial transaction information for payment satisfaction through an on-line payment system web service provider and with a peripheral and/or host device for processing a commercial transaction for which payment is transferred; and
a network adapter in communication with the processing unit configured and arranged to transmit a request to the on-line payment system web service provider including the transaction information to use the on-line payment system web service provider's Internet payment services and to receive a payment status response from the on-line payment system web service provider.

24. The appliance of claim 23, wherein the network adapter is a wireless radio configured and arranged to transmit and receive data over a cellular network.

25. The appliance of claim 23, wherein the processing unit is remotely programmable via the network adapter to interface with a peripheral and/or host device.

26. The appliance of claim 23, wherein the processing unit is remotely programmable via the network adapter to interface with an on-line payment system web service provider.

27. The appliance of claim 25, wherein the peripheral and/or host device is a point-of-sale terminal.

28. The appliance of claim 25, wherein the peripheral and/or host device is a printer.

29. A method of consuming a third party web service on the Internet by way of a thin client Internet appliance and a client-server network architecture comprising:
transmitting from the thin client appliance over the Internet via a cellular network to a web service proxy server a web service consumption request, wherein the web service proxy server receives the request, generates a service request message based on an established protocol to transmit the service request message in accordance with the third party web service's API specification and protocol, and receives a return message from the third party web service; and
receiving over the Internet at the thin client appliance transaction information from the web service proxy server, wherein the transaction information is extrapolated from the return message.

30. The method of claim 29, further comprising the step of transmitting to the web service proxy server any information for storage in a database and/or to be made available over the Internet by providing the web service API interface.

31. The method of claim 29, wherein the reception occurs via a cellular network.

32. A thin client Internet appliance for consuming a third party web service on the Internet using a client-server network architecture comprising:
a processing unit configured and arranged to generate a web service consumption request and to interpret transaction information; and
a network adapter configured and arranged to transmit over the Internet to a web service proxy server a web service consumption request, wherein the web service proxy server receives the request, generates a service request message based on an established protocol to transmit the service request message in accordance with the third party web service's API specification and protocol, and receives over the Internet a return message from the third party web service, and to receive transaction information from the web service proxy server, wherein the transaction information is extrapolated from the return message.

33. The appliance of claim 32, wherein the network adapter is a wireless radio configured and arranged to connect to the Internet via a cellular network.

34. A method of completing a commercial transaction, where a commercial transaction request is made at a location other than where the commercial transaction is to be fulfilled using a thin client Internet appliance, comprising:
receiving at the fulfillment location a code input and obtained by a customer, wherein the customer placed a commercial transaction request over the cellular network with an order placement server that provided the customer with the code;
transmitting the inputted code over the cellular network to a remote server, where the remote server matches the received code with the commercial transaction request; and
communicating to a peripheral and/or host device the details of the matched commercial transaction request for completion of the commercial transaction.

35. A thin client Internet appliance for completing a commercial transaction, where a commercial transaction request is made at a location other than where the commercial transaction is to be fulfilled, comprising:
a processing unit configured and arranged to receive an inputted code associated with a commercial transaction request and to transmit to a peripheral and/or host device the details of the matched commercial transaction for completion of the commercial transaction; and
a cellular wireless radio configured and arranged to transmit the inputted code to an order placement server for matching the code with its associated commercial transaction and to receive details of the matched commercial transaction request from the order placement server.
